(19) United States
(12) Patent Application Publication
(10) Pub. No.: US 2026/0191276 A1
(43) Pub. Date: Jul. 9, 2026

(54) AEROSOL PROVISION DEVICE

(71) Applicant: Nicoventures Trading Limited, London (GB)

(72) Inventors: Matthew HODGSON, London (GB); Dean COWAN, London (GB); Benjamin TAYLOR, London (GB)

(21) Appl. No.: 19/125,700

(22) PCT Filed: Oct. 24, 2023
(86) PCT No.: PCT/EP2023/079652

§ 371 Date: Apr. 29, 2025

(30) Foreign Application Priority Data
Oct. 31, 2022 (GB) 2216103.8

(51) Int. Cl. A24F 40/57; A24F 40/46; A24F 40/465; A24F 40/53; H05B 1/02

(52) U.S. Cl. CPC A24F 40/57; A24F 40/46; A24F 40/465; A24F 40/53; H05B 1/0252

(57) ABSTRACT

An aerosol provision device for generating an aerosol from aerosol-generating material is provided. The device comprises a heating arrangement and a stop. The heating arrangement is configured to receive at least a portion of an article containing aerosol-generating material.

The stop arranged to abut an end of the portion of the article received by the heating arrangement to limit an extent by which the portion of the article is received by the heating arrangement. The stop is arranged to move relative to the heating arrangement between a first stop position and a second stop position to vary a useable extent of the heating arrangement. In the second stop position a portion of the heating arrangement is at least partially deactivated.

### CROSS-REFERENCE TO RELATED APPLICATIONS

This present application is a National Phase entry of PCT Application No.

PCT/EP2023/079652, filed Oct. 24, 2023, which claims priority from GB 2216103.8, filed Oct. 31, 2022, each of which are fully incorporated herein by reference in their entireties.

### TECHNICAL FIELD

The present invention relates to an aerosol provision device for generating an aerosol from aerosol-generating material. The present invention also relates to a method of operating an aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an aerosol provision device for generating an aerosol from aerosol-generating material comprising: a heating arrangement configured to receive at least a portion of an article containing aerosol-generating material; a stop arranged to abut an end of the portion of the article received by the heating arrangement to limit an extent by which the portion of the article is received by the heating arrangement, wherein the stop is arranged to move relative to the heating arrangement between a first stop position and a second stop position to vary a useable extent of the heating arrangement, and wherein in the second stop position a portion of the heating arrangement is at least partially deactivated.

The useable extent of the heating arrangement may define a heating zone in which a portion of the article is heated.

A depth of the heating zone may vary between the first stop position and the second stop position.

A first proportion of the heating arrangement may be operated to heat the heating zone in the first stop position and a different second proportion of the heating arrangement may be operated to heat the heating zone in the second position.

The first and second proportions of the heating arrangement may overlap.

The first proportion may encompass the second proportion of the heating arrangement.

In the first stop position the full extent of the heating arrangement may be operated to heat the heating zone.

In the first stop position a first portion of the heating arrangement may be at least partially deactivated.

In the second stop position a second portion of the heating arrangement may be at least partially deactivated

The portion of the heating arrangement that is at least partially deactivated may be outside the heating zone.

The heating arrangement may comprise a receptacle arranged to receive at least the portion of the article containing aerosol-generating material.

The stop may define a base of the receptacle.

The stop may be movable in the receptacle.

The heating arrangement may comprise a heating member.

The heating member may extend from the stop to define the heating zone.

The heating member may be tubular and may define at least part of the receptacle.

The stop may be movable in the heating member.

The stop may be arranged to be received in at least the portion of the article containing aerosol-generating material.

The stop may upstand from the base.

The stop may define a useable extent of the heating member exposed to the heating zone, and a non-useable extent unexposed to the heating zone.

When the stop is in the first stop position, the heating arrangement may be configured to heat a first usable extent of the heating member and to limit heating of a first non-usable extent of the heating member.

When the stop is in the second stop position, the heating arrangement may be configured to heat a second usable extent of the heating member and to limit heating of a second non-useable extent of the heating member

The heating member may comprise at least two heating portions that are independently heatable.

The second stop position corresponds to the juncture of adjacent heating portions.

The heating member may comprise at least two heating elements.

The heating elements may be heating bands.

The heating bands may be selectively exposed dependent on stop position.

The heating arrangement may comprise an inductor coil arrangement comprising inductor coil portions that are independently operable to heat different regions of the heating member.

Each inductor coil portion may comprise an inductor coil.

The heating member may be susceptible to heating by exposure to a varying magnetic field.

The device may comprise a controller to control operation of the heating arrangement.

In a first operating condition, the controller may be arranged to operate a first proportion of the heating arrangement.

In a second operating condition, the controller may be arranged to operate a second proportion of the heating arrangement.

The operating condition may be a determined position of the stop.

The controller may be configured to determine the position of the stop and to operate the heating arrangement in dependence on the determined position.

The controller may be configured to determining whether a stop is in a first stop position or a second stop position; and may at least partially deactivate a portion of the heating arrangement when the stop is determined to be in the second stop position.

When the stop is in the first stop position, the controller may be configured to operate the heating arrangement according to a first heating profile.

When the stop is in the second stop position, the controller may be configured to operate the heating arrangement according to a second heating profile and the first heating profile may be different to the second heating profile.

The heating profile may comprise at least one of an operating temperature and a session length.

The first and the second heating profile may vary along the length of the heating zone.

The first heating and the second heating profile may vary with time.

According to another aspect, there is provided an aerosol provision system comprises an article comprising aerosol-generating material and the aerosol provision device.

The article may be a consumable.

According to an aspect, there is provided a heating arrangement configured to receive at least a portion of an article containing aerosol-generating material; a stop arranged to abut an end of the portion of the article received by the heating arrangement to limit an extent by which the portion of the article is received by the heating arrangement, wherein the stop is arranged to move relative to the heating arrangement between a first stop position and a second stop position to vary a useable extent of the heating arrangement. In the second stop position a portion of the heating arrangement may be at least partially deactivated.

According to an aspect, there is provided a method of operating an aerosol provision device comprising a heating arrangement configured to receive at least a portion of an article containing aerosol-generating material, the method comprising: operating the device in a first operating condition in which the heating arrangement is operated and the stop is in a first stop position, wherein the stop is arranged to abut an end of the portion of the article received by the heating arrangement to limit an extent by which the portion of the article is received by the heating arrangement, and operating the device in a second operating condition in which the stop is in a second stop position, in which a portion of the heating arrangement is at least partially deactivated and the stop has been moved relative to the heating arrangement between the first stop position and the second stop position to vary a useable extent of the heating arrangement.

The method may comprise determining whether a stop is in a first stop position or a second stop position and at least partially deactivating a portion of the heating arrangement when the stop is determined to be in the second stop position.

According to an aspect, there is provided an aerosol provision device for generating an aerosol from aerosol-generating material comprising: a heating arrangement configured to receive at least a portion of an article containing aerosol-generating material, an article sensor and a controller, wherein the controller is configured to: determine a characteristic of the article in dependence on a property of the article detected by the article sensor, select a heating profile of the heating arrangement in dependence on the determined characteristic, and operate the heating arrangement based on the selected heating profile.

### BRIEF DESCRIPTION OF THE DRAWINGS

Embodiments will now be described, by way of example only, and with reference to the accompanying drawings in which:

FIG. 1A shows schematically an aerosol provision system with an aerosol provision device and an article received into the device;

FIG. 1B shows schematically an aerosol provision system with an aerosol provision device and an article received into the device;

FIG. 2A shows schematically part of the aerosol provision system of FIG. 1A with the aerosol provision device in a first configuration;

FIG. 2B shows schematically part of the aerosol provision system of FIG. 1A with the aerosol provision device in a second configuration;

FIGS. 3A, 4A and 5A show schematically part of the aerosol provision device of FIG. 1A in a first operating condition;

FIGS. 3B, 4B and 5B shows schematically part of the aerosol provision device of FIG. 1A in a second operating condition;

FIG. 6A shows schematically part of the aerosol provision device of FIG. 1B in a first operating condition;

FIG. 6A shows schematically part of the aerosol provision device of FIG. 1B in a second operating condition;

FIG. 7A shows schematically part of an aerosol provision device in a first operating condition; and

FIG. 7B shows schematically part of the aerosol provision device of FIG. 7A in a second operating condition.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol generating material may include any plant-based material, such as tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilise at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporise an aerosol generating material in the form of a liquid, which may or may not contain nicotine. The aerosol generating material may be in the form of or be provided as part of a rod, cartridge or cassette or the like which can be inserted into the apparatus. A heater for heating and volatilising the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

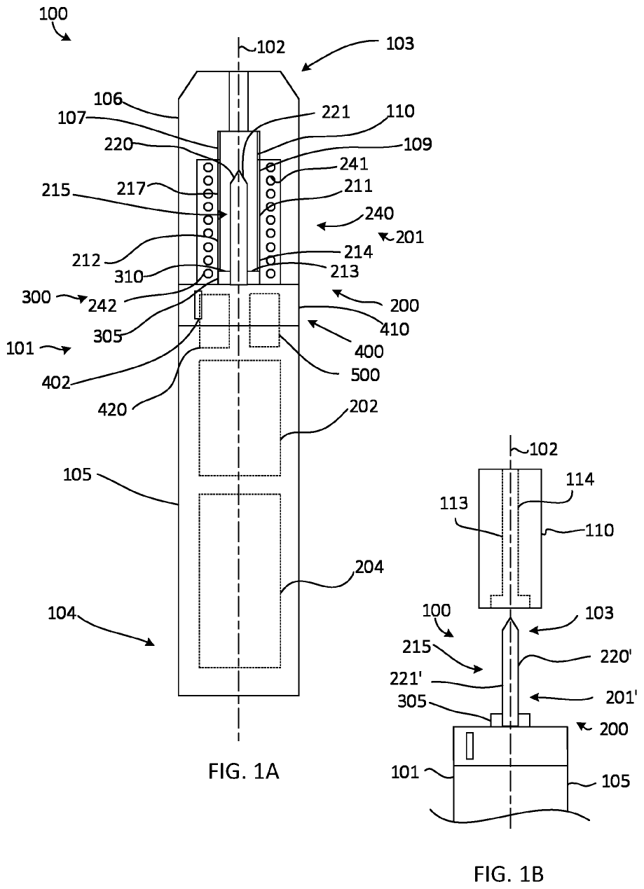

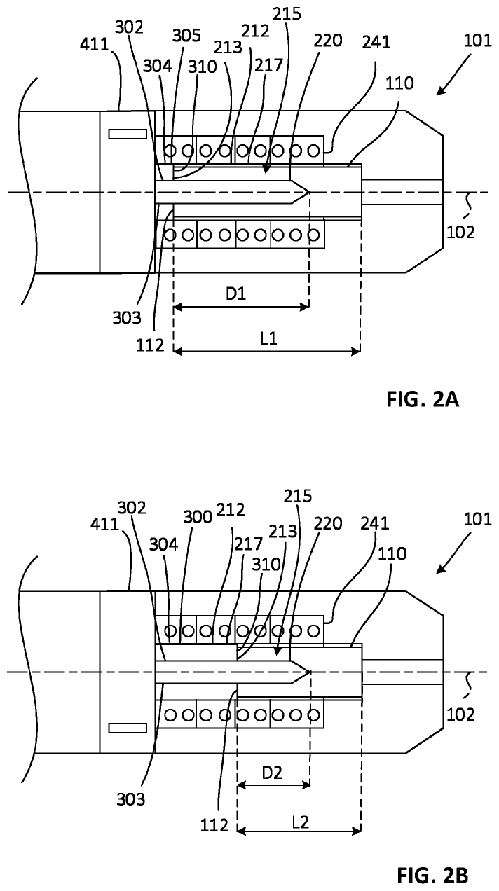

FIGS. 1A, 2A and 2B show an aerosol provision system 100. The system 100 comprises an aerosol provision device 101 for generating aerosol from an aerosol generating material, and a replaceable article 110 comprising the aerosol generating material. The device 101 can be used to heat the replaceable article 110 comprising the aerosol generating material, to generate an aerosol or other inhalable material which can be inhaled by a user of the device 101. The article 110 may be fully or partially received by the device 101 for heating by the device 101. In the arrangement shown in the Figures, the article 110 is fully received by the device 101. In embodiments, the article 110 protrudes from the device 101.

The device 101 defines a longitudinal axis 102, along which an article 110 may extend when received by the device 101. In use, a user draws on the device or the article to draw aerosol generated in the device. This causes the aerosol to flow through the article 110 along a flow path towards a proximal end 103 of the device 101. The proximal end (or mouth end) 103 of the device 101 is the closest to the mouth of the user when device 101 is in use. The other end of the device 101, furthest away from the proximal end 103, is known as the distal end 104 of the device 101 because, in use, it is the end furthest away from the mouth of the user.

As a user draws on the aerosol generated in the device, the aerosol flows in a direction towards the proximal end 103 of the device 101. The terms proximal and distal as applied to features of the device 101 will be described by reference to the relative positioning of such features with respect to each other in a proximal-distal direction along the axis 102.

The device 101 comprises a body 105. The body 105 comprises a housing, which surrounds and houses various components of the device 101. The housing is elongate. In embodiments, such as the one of FIG. 1A, the device 101 comprises an auxiliary body 106.

The auxiliary body 106 is removably attachable to the body 105. In embodiments, the body 105 and the auxiliary body 106 form a single unit. In embodiments, such as the one of FIG. 1B, the auxiliary body is omitted.

The device 101 includes a heating assembly 200 for heating aerosol-generating material. The heating assembly 200 includes a heating arrangement 201, a controller (control circuit) 202, and a power source 204. The heating assembly 200 may include a chassis and other components forming part of the device 101. The heating arrangement 201 is configured to heat the aerosol-generating material of the article 110 received into the device 101, such that an aerosol is generated from the aerosol generating material. The heating arrangement 201 may comprise various components to heat the aerosol generating material of the article 110.

The power source 204 supplies electrical power to the heating arrangement 201, and the heating arrangement 201 converts the supplied electrical energy into heat energy for heating the aerosol-generating material. The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The power source 204 may be electrically coupled to the heating arrangement 201 to supply electrical power when required and under control of the controller 202 to heat the aerosol generating material. The control circuit 202 may be configured to selectively activate and deactivate the heating arrangement 201, or parts of, based on a user input. The control circuit 202 may further be configured to selectively operate the heating arrangement 201 according to an operating condition of the device 101 being detected. In embodiments, the controller is configured to determine the position of the stop 305 and to operate the heating arrangement 201 in dependence on the determined position.

The heating arrangement 201 defines a heating zone 215 in which the portion of the article 110 received by the heating arrangement 201 is heated. The heating arrangement 201 includes a heating member 220. The heating member 220 comprises at least one heating element 221. The heating element 221 is configured to heat the heating zone 215 via induction heating. Other forms of heating arrangement, and therefore heating element, are anticipated such as resistance heating. The heating element 221 defines the heating zone 215.

In embodiments, the heating arrangement is an inductive heating arrangement. Induction heating is a process of heating an electrically conducting heating element (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

In the embodiment of FIG. 1A, the heating arrangement 201 is an inductive heater arrangement. The heating element 221 is an induction heating element. That is, the heating element 221 comprises a susceptor that is heatable by penetration with a varying magnetic field. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The inductive heater arrangement further comprises a magnetic field generator 240. The magnetic field generator 240 is configured to generate one or more varying magnetic fields that penetrate the susceptor so as to cause heating in the susceptor. The magnetic field generator 240 includes an inductor coil arrangement 241. The inductor coil arrangement 241 comprises a plurality of inductor coils 242. Each coil in the plurality of inductor coils 242, acts as an inductor element. The plurality of inductor coils 242 encircles the heating zone 215. The plurality of inductor coil 242 extends around at least a portion of the heating member 220. In other embodiments, the plurality of inductor coils 242 may instead extend in the heating member 220. The number of inductor coils may differ.

Each coil in the plurality of inductor coils 242 is a helical coil, however other arrangements are envisaged. In embodiments, the plurality of inductor coils 242 comprises two or more inductor coils. The two or more inductor coils in embodiments are disposed adjacent to each other and may be aligned co-axially along the axis. Each helical coil in the plurality of inductor coils 242 is configured to generate a varying magnetic field that penetrates the heating element 221. The heating element 221 acts as a susceptor. Each helical coil in the plurality of inductor coils 242 is arranged coaxially with longitudinal axis 102. Each helical coil in the plurality of inductor coils 242 comprises electrically-conductive material, such as copper. The coil is formed from wire, such as Litz wire, which is wound helically around a support member. In embodiments, the support member is omitted. The support member is tubular. The plurality of coils 242 defines a generally tubular shape. Each coil in the plurality of inductor coils 242 has a generally circular profile. In other embodiments, each coil in the plurality of inductor coils 242 may have a different shape, such as generally square, rectangular or elliptical. Each coil in the plurality of inductor coils 242 may have a width which increases or decreases along its length.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximised. By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, each inductor coil of the plurality of inductor coils 242 may have substantially the same or different values of inductance, axial lengths, radii, pitches, numbers of turns, etc.

In some examples, in use, the plurality of inductor coils 242 is configured to heat the heating element 221 to a temperature of between about 200° C. and about 350° C., such as between about 240° C. and about 305° C., or between about 250° C. and about 280° C.

The device 101 includes a stop assembly 300. The stop assembly 300 comprises a stop 305 and an actuation assembly 400. The stop 305 is moveable in relation to the heating arrangement 201. The stop 305 is arranged to abut an end of the portion of the article 110 received by the heating arrangement 201. The stop 305 limits an extent by which the portion of the article 110 is received by the heating arrangement 201. The axial length of the article is the distance between an insertion end 112 of article 110 and a proximal end of article 110. The insertion end 112 of the article 110 is arranged to contact the stop when the article is received into the device 101. In embodiments, the stop assembly is omitted.

The stop 305 is arranged to move between a first stop position to provide a first useable extent of the heating arrangement 201, and a second stop position to provide a second, different, useable extent of the heating arrangement 201. Advantageously, adjusting the useable extent of the heating arrangement 201 allows for articles of varying lengths to be used with device 101 and/or for different lengths of portions of aerosol generating material in an article to be used with the device 101.

The stop 305 may be formed free of material that is heatable by penetration with a varying magnetic field. The stop 305 may be formed from an insulating material. For example, the stop 305 may be formed from a plastic, such as polyether ether ketone (PEEK). Other suitable materials are possible. Using a non-metallic material for the stop 305 may assist with restricting heating of other components of the device 101 and/or with preventing burning of the aerosol generating material.

The actuation assembly 400 comprises a user-operable actuation element 410 and an actuation mechanism 420. The actuation element 410 is configured to adjust the device 101 for use with the dimensions of a selected article 110 to be received by the device. In the embodiments, the actuation element 410 comprises a rotary collar 411. In other embodiments, the actuation element 410 may have a different configuration, for example may comprise at least one of a button, a sliding button, a slider and a switch. The actuation mechanism 420 is mechanically or electrically connected to the actuation element 410. The actuation mechanism 420 may be an actuator or an electric motor. The actuation mechanism 420 is configured to move the stop 305 in relation to the heating arrangement 201 in response to actuation element 410 being operated. The actuation mechanism 420 is configured to move the stop 305 to adjust a usable extent of the heating arrangement 201. That is, the extent by which the portion of the article is received by the heating arrangement 201. The actuation assembly 400 further comprises an indicator element 402. In some embodiments, the indicator element may be omitted. The indicator element 402 provides visual indication to a user about the position of the stop 305. The indicator element 402 is shown as a raised element but may instead comprise a notch, a marking or a light.

In embodiments, the device 101 includes a sensor assembly 500. In embodiments, the sensor assembly 500 includes an article sensor (not shown). The article sensor is configured to detect whether an article, such as the article 110, or a portion of an article is received by the device 101. The article sensor is configured to detect a property of the article 110 received by the device 101. In embodiments, the property of the article is indicative of an article length or a length of the aerosol generating material of the article. The property of the article may, for example, comprise a RFID tag and/or a QR code. The RFID tag and/or the QR code may be provided on the article 110. The property of the article may comprise a physical property of the article 110. The physical property of the article 110 may be a dimension of the article or a distinguishing feature provided on the article. Based on an input of the article sensor, the controller 202 may operate the device 101 based in a pre-determined operating condition. Based on an input of the article sensor, the controller 202 may operate the heating arrangement 201 according to a selected heating profile.

With reference to FIGS. 2A and 2B, the heating arrangement 201 of the embodiment of FIG. 1A will be described in more detail. The heating arrangement 201 comprises the inductor coil arrangement 241, the heating member 220, a heating chamber 211 and the stop 305. The heating member 220 comprises the heating element 221. The heating element 221 acts as a susceptor.

The heating chamber 211 is configured and dimensioned to receive at least a portion of the article 110 to be heated. The heating chamber 211 is formed by a receptacle 212. The receptacle 212 acts as a support member. The receptacle 212 comprises a generally tubular member. The receptacle 212 extends along and around and is substantially coaxial with the longitudinal axis 102 of the device 101. However, other shapes would be possible. The receptacle 212 is open at its proximal end such that an article 110 can be received by the heating chamber 211 therethrough. The receptacle 212 may comprise one or more conduits that form part of an air path.

The receptacle 212 is formed free of material that is heatable by penetration with a varying magnetic field. The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating arrangement 201 is operated. Using a non-metallic material for the receptacle 212 may assist with restricting heating of other components of the device 101. The receptacle 212 may be formed from a rigid material to aid support of other components. In embodiments, however, the receptacle 212 comprises material that is heatable by penetration with a varying magnetic field. In embodiments. The receptacle is formed, at least in part, by the heating element.

The auxiliary body 106 comprises an auxiliary receiving chamber 107. The auxiliary receiving chamber 107 and the receptacle 212 are axially aligned. The auxiliary receiving chamber 107 acts a continuation of the receptacle 212 when the auxiliary body 106 is attached to the body 105. The inner dimensions of the auxiliary receiving chamber 107 perpendicular to longitudinal axis 102 substantially correspond to the inner dimensions of the receptacle 211 perpendicular to longitudinal axis 102. The auxiliary receiving chamber 107 may guide insertion of article 110 into the receptacle 212. The auxiliary chamber 107 and the receptacle 212 comprise an article receiving chamber 109. The article receiving chamber 109 is sized to enclose the article 110 although other configurations are envisaged. For example, a proximal end of the auxiliary body 106 may comprise an opening through which the article 101 is inserted. In embodiments, the auxiliary body 106 is omitted.

The article 110 is generally cylindrical, and the heating chamber 211 is correspondingly generally cylindrical in shape, however, other shapes would be possible. The article 110 is sized to be received by the receptacle 212. The outer dimensions of the article 110 perpendicular to the longitudinal axis of the article 110 substantially correspond with the inner dimensions of the heating chamber 211 perpendicular to the longitudinal axis 102 of the device 101 to allow insertion of the article 110 into the receptacle 212.

The heating member 220 extends into the heating chamber 211 from the distal end of the heating chamber 211 along the longitudinal axis 102 of the device (in the axial direction). In embodiments, the heating member 220 extends into the heating chamber 211 spaced from the axis 102. The heating member 220 may be off-axis or non-parallel to the axis 102. The heating member 220 defines the heating zone 215 in a part of the heating chamber 211. In embodiments, the heating zone 215 is defined along the entire extent of the heating chamber 211.

The heating member 220 upstands from a distal end of the receptacle 212. In embodiments, a base of the receptacle 212 is provided at the distal end of the receptacle 212. The base is defined by an end wall 213. The heating member 220 is spaced from the peripheral wall 214. The heating arrangement 201 is configured such that when an article 110 is received by the heating chamber 211, a portion of the heating element 221 extends into a distal end of the article 110. The portion of the heating element 221 extending into the distal end of the article 110 defines an axial extent of overlap of the heating member 220 and the article 110. The heating member 220 is positioned, in use, within the article 110. The heating member 220 is configured to heat the aerosol generating material of the article 110 from within, and for this reason is referred to as an inner heating element. In embodiments, at least part of the receptacle 212 is defined by the heating member. In such embodiments, the heating member is configured to receive the article 110. In such embodiments, the heating member is generally tubular. In such embodiments, the heating element is configured to heat aerosol generating material of the article 110 from the outside, and for this reason is referred to as an outer heating element.

FIG. 2A shows the stop in a first position and FIG. 2B shows the stop 305 in a second position. The stop 305 is moveable in relation to the heating arrangement 201. The stop 305 is moveable in the receptacle 212. The stop 305 is generally tubular. The stop 305 protrudes in the receptacle 212. The stop 305 acts as the end wall 213. The stop 305 comprises a stop surface 310. The stop surface 310 acts as the base. The stop surface 310 faces the open proximal end of the receptacle 212. The stop 305 closes the receptacle 212 at its distal end.

The stop 305 comprises an inner surface 303 and an outer surface 304. The stop surface 310 is configured to abut the insertion end 112 of the article 110. The stop 305 limits the extent of insertion of the article 110 into the heating zone 215. The stop 305 is sized to be received in receptacle 212. The outer dimensions of stop 305, perpendicular to the longitudinal axis 102 of the device, substantially correspond with the inner dimensions of receptacle 212. The outer surface 304 of stop 305 and the inner side 217 of the receptacle 212 form a slide fit.

The stop 305 encircles a portion of heating member 220. The inner surface of stop 305 defines a bore 302. The bore 302 extends along the longitudinal axis 102 of the device 101. The bore 302 is sized to receive the heating member 220. The bore 302 and the heating member 220 are complimentary sized to form a slide fit. The inner surface 303 may be in contact with the outer surface of the heating member 220. The stop 305 encircles a portion of the heating member 220 to reduce the usable extent of the heating member 220. The usable extent of the heating member is defined as a portion of the heating member 221 exposed to the heating zone 215 and available to heat a portion of the article 110.

The stop 305 is movable relative to receptacle 212 and the heating member 220. The receptacle 212 and the heating member 220 are in a fixed position. The stop 305 slides over the outer surface of heating member 220. The stop 305 moves from the first stop position to the second stop position along the longitudinal axis 102 of device 101. The first stop position and the second stop position are different axial positions of the stop 305.

FIG. 2A shows the device 101 receiving an article 110 having first pre-determined dimensions. The first pre-determined dimensions may correspond to a first axial length L1 of the article 110. The stop 305 is shown in the first stop position. In the first stop position, the stop 305 provides a first useable extent of the heating arrangement 201. In the first stop position, the stop 305 overlaps a first portion of the heating member 220. In the first stop position, the stop 305 overlaps a first portion of the inductor arrangement 241.

FIG. 2B shows the device 101 receiving an article 110 having second pre-determined dimensions. The second pre-determined dimensions may correspond to a second axial length L2 of the article 110. The stop 305 is shown in the second stop position. In the second stop position, the stop 305 provides a second useable extent of the heating arrangement 201. The second usable extent of the heating arrangement 201 is different to the first useable extent of the heating arrangement 201. In the second stop position, the stop 305 overlaps a second portion of heating member 220. In the second stop position, the stop 305 overlaps a second portion of the inductor arrangement 241. The second portion of heating member 220 is different in length to the first portion. The axial extent of overlap of the heating element 220 and the article 110 abutting the stop 305 differs in the first stop position and in the second stop position. The second portion of inductor arrangement 241 is different in length to the first portion. The axial extent of overlap of the inductor arrangement 241 and the article 110 abutting the stop 305 differs in the first stop position and in the second stop position.

The rotary collar 411, acting as an actuator, is illustrated as having a first circumferential position, and a second circumferential position. FIG. 2A shows the rotary collar 410 in the first circumferential position and FIG. 2B shows the rotary collar 410 in the second circumferential position. When the rotary collar 411 is in the first circumferential position, the stop 305 is in the first stop position. When the rotary collar 411 is in the second circumferential position, the stop 305 is in the second stop position. Moving the rotary collar 411 from the first circumferential position to the second circumferential position causes the stop 305 to move from the first stop position to the second stop position. Moving the rotary collar 411 from the second circumferential position to the first circumferential position causes the stop 305 to move from the second stop position to the first stop position. In the present embodiment, the rotary collar 411 is shown as having two circumferential positions. In other embodiments, the rotary collar 411 may have three or more circumferential positions each corresponding to a stop position of stop 305. The actuator in embodiments is arranged to adjust the stop between a pre-determined number of discrete positions, or is continuously variable across the range of movement of the stop 305.

The first stop position of stop 305 is pre-determined so as to configure the device 101 to receive an article 110 having a first length L1. The second stop position of stop 305 is pre-determined so as to configure the device 101 to receive an article 110 having a second length L2, different to the first length L1. In some embodiments, the first stop position of stop 305, is pre-determined to provide a first axial extent of overlap of the heating member 220 and an article 110 abutting the stop 305. The second stop position of stop 305 is pre-determined to provide a second axial extent of overlap of the heating member 220 and an article 110 abutting the stop 305. The first axial extent of overlap is different to the second axial extent of overlap. In some embodiments, the first stop position of stop 305, is pre-determined to provide a first useable extent of the heating arrangement 201 and the second stop position of the stop 305, is pre-determined to provide a second useable extent of the heating arrangement 201.

In use of the device 101, prior to inserting an article 110 into the device 101, a user moves the rotary collar 411 to the first circumferential position or to the second circumferential position to configure the device 101 for use with the first article having the first length L1 or the second article having the second length L2 respectively. As a result, actuation mechanism 420 moves the stop 305 to the first stop position or to the second stop position respectively. The user then insert the corresponding first or second article into the device until the insertion end 112 abuts the stop 305. In some embodiments, the overall lengths of the first and second article may be substantially the same but the first article may have a first length of aerosol generation material and the second article may have a second, different length of aerosol generating material.

In embodiments, the heating arrangement is a resistive heating arrangement. A resistive heating arrangement may comprise a resistive heating generator including components to heat a heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating arrangement comprises electrical contacts for supplying electrical current to the resistive material. The resistive heating component may transfer heat to a heating element, for example by conduction. The heating element may form the resistive heating component itself. The heating element may be provided on a heating member.

With reference to FIG. 1B, another embodiment of the heating arrangement will be described in more detail. The heating arrangement 201′ forms part of an aerosol provision device, such as the device 101. The heating arrangement 201′ is a resistive heating arrangement. The heating arrangement 201′ comprises a heating member 220′. The heating member 220′ comprises a heating element 221′. In the embodiment of FIG. 1B, the heating chamber 211 is omitted. The heating arrangement 201′ is free from a receptacle. That is, the heating zone 215 is free from being surrounded or delimited by any other component. A substantial portion of the heating element 221′ is exposed. Optionally, at least 80% of the heating element 221′ is exposed, optionally 60% is exposed, or optionally 50% is exposed. The heating element 221′ extends beyond an external extent of the body 105 of the device 101. The heating member 220′ upstands from a base of the body 105. The base is formed by the stop surface 310 of the stop 305. In other embodiments, the base comprises an external surface of the body 105.

The heating member 220′ defines the heating zone 215. At least a portion of the article 110 is configured to be received in the heating zone 215. The heating member 220′ is configured to be received into the article 110 when the portion of the article 110 is received in the heating zone 215. The heating member 220′ is configured to be received into the article 110 when the device 101 is in use.

The article 110 comprises a bore 113. The bore 113 is pre-formed in the article 110. The bore 113 in embodiments extends partially along the longitudinal axis 102 of the article 110. The bore 113 comprises an inner surface 114. The bore 113 is open at the insertion end 112 of the article 110. The heating member 220′ is sized to be received in the bore 113. The heating member 220′ and bore 113 are complimentary sized to form a contact fit. The inner surface 114 of the bore is configured to form a close contact with the heating member 220′ to maximise heat transfer between the heating member 220′ and the aerosol generating material of the article 110. The bore 113 is configured to accommodate the stop 305. In embodiments where the configuration of the heating arrangement 201 varies, the bore 113 is provided as a complimentary cavity. In embodiments the outer dimensions of the heating member 220′ are greater than those of the bore 113. In such arrangements, the heating member 220′ is configured to deform and/or distend the article 110 to be inserted into the device 101. In other embodiments, bore 113 is omitted such that the article is free from a bore, and the heating member 220′ deforms and/or distends the article upon insertion.

The stop 305 is moveable in relation to the heating arrangement 201′. In the embodiment shown, the stop 305 is moveable along the longitudinal axis 102 of the device. The stop 305 is generally tubular. The stop 305 protrudes beyond an external extent of the body 105 of the device 101. In embodiments, the stop 305 acts as the base of the heating arrangement 201′. The stop 305 comprises a stop surface 310. The stop surface 310 acts as the base of the heating arrangement 201. The stop surface 310 is configured to abut the insertion end 112 of the article 110. The stop 305 limits the extent of insertion of the article 110 into the heating zone 215. The stop 305 limits the extent of insertion of the heating member 220′ into the article 110. In embodiments, the outer dimensions of stop 305, perpendicular to the longitudinal axis 102 of the device, substantially correspond with an inner dimensions of the bore 113 of the article 110. In embodiments, the stop 305 is sized to be partially or fully received into the article 110.

The stop 305 encircles a portion of heating member 220′. The inner surface of stop 305 defines a bore 302. The bore 302 extends along the longitudinal axis 102 of the device 101. The bore 302 is sized to receive the heating member 220′. The bore 302 and the heating member 220′ are complimentary sized to form a slide fit. The inner surface 303 may be in contact with the outer surface of the heating member 221. The stop 305 encircles a portion of the heating member 221 to reduce the usable extent of the heating member 220. The usable extent of the heating member 220′ is defined as a portion of the heating member 220 exposed to the heating zone 215 and available to heat a portion of the article 110.

The stop 305 is movable relative to the heating member 220′. The heating member 220′ is in a fixed position. The stop 305 slides over the outer surface of heating member 220′. In different stop positions, the stop 305 overlaps different portions of the heating member 220′. In different stop positions, the axial extent of overlap of the heating member 220′ and the article 110 differ.

In embodiments, an inductive coil extends in the heating member 220′ and the heating arrangement 201′ comprises an inductive heater arrangement.

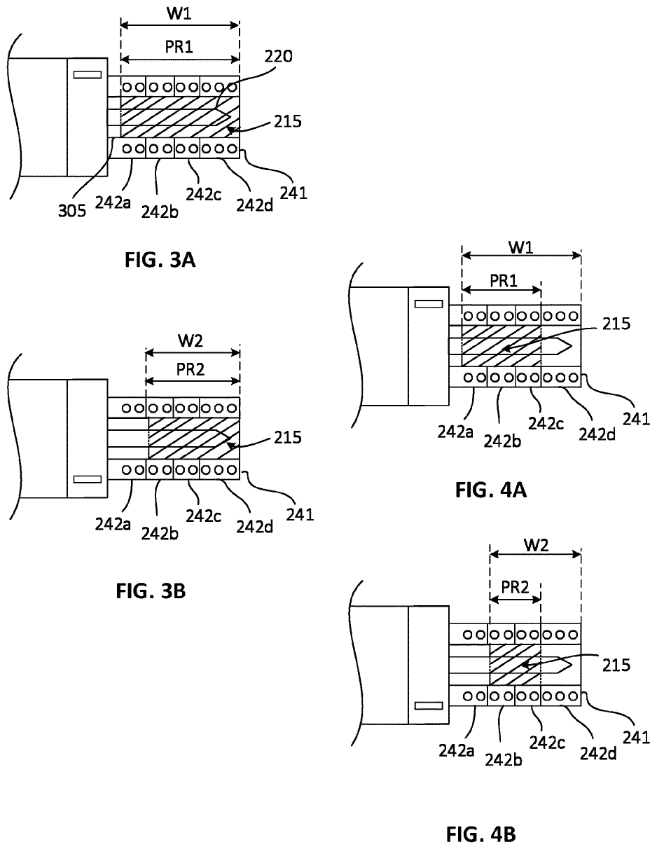

With reference to FIGS. 3A to 7B, the heating arrangement 201, 201′ can be operated selectively based on an operating condition of the device 101. Based on the operating condition, the full extent of the heating arrangement 201, 201′, or only a proportion of the heating arrangement 201, 201′, is operated. As used herein, the term “operated” means configured to selectively, intermittently or continuously heat the heating zone 215, or parts of, during use of the device 101.

The device 101 may have any number of operating conditions. Each operating condition may correspond to a different proportion of the heating arrangement being operated. In embodiments, the same proportion of the heating arrangement may be operated based on one or more distinct operating conditions of the device.

In a first operating condition of the device 101, a first proportion PR1 of the heating arrangement 201, 201′ is operated. In a second operating condition of the device 101, a portion of the heating arrangement 201, 201′ is at least partially deactivated such that a second, different proportion PR2 of the heating arrangement 201, 201′ is operated.

In embodiments, no portion of the heating arrangement 201, 201′ is deactivated in the first operating condition and the first proportion PR1 corresponds to the full extent of the heating arrangement 201, 201′. In other embodiments, a first portion of the heating arrangement 201, 201′ is at least partially deactivated in the first operating condition and a second portion of the heating arrangement 201, 201′ is at least partially deactivated in the second operating condition.

In embodiments, the first proportion PR1 of the heating arrangement 201, 201′ comprises the full extent of the heating arrangement 201, 201′, optionally at least 80% of the full extent of the heating arrangement 201, 201′, optionally at least 60% or optionally at least 50%. In embodiments, the second proportion PR2 of the heating arrangement 201, 201′ comprises optionally at least 80% of the full extent of the heating arrangement 201, 201′, optionally at least 60% or optionally at least 50%.

When operated, the first proportion PR1 of the heating arrangement 201, 201′ defines the heating zone 215. When operated, the second proportion PR2 of the heating arrangement 201, 201′ defines the heating zone 215. The heating zone 215 defined by the first proportion PR1 of the heating arrangement 201, 201′ may differ in at least one aspect from the heating zone 215 defined by the second proportion PR2 of the heating arrangement 201, 201′. In embodiments, the heating zone 215 may have a first depth D1 when defined by the first proportion PR1 of the heating arrangement 201, 201′ and a second depth D2 when defined by the second proportion PR2 of the heating arrangement 201, 201′. In embodiments, the heating zone 215 may be heated according to a first heating profile when defined by the first proportion PR1 of the heating arrangement 201, 201′ and according to a second heating profile when defined by the second proportion PR2 of the heating arrangement 201, 201′. Advantageously, the characteristics of the heating zone 215 can thus be varied by operating different proportions of the heating arrangement 201, 201′.

In embodiments, the operating condition is a determined position of the stop 305. In any particular stop position, the heating arrangement 201, 201′ may be operated to its full extent or one or more portions of the heating arrangement 201, 201′ may be at least partially deactivated. When the stop 305 is in the first stop position, a first proportion PR1 of the heating arrangement 201 is operated. When the stop 305 is in the second stop position, a second, different proportion PR2 of the heating arrangement 201 is operated. It will be appreciated that the stop may take any number of discrete positions. Each discrete stop position may correspond to a different proportion of the heating arrangement being operated. In embodiments, the same proportion of the heating arrangement may be operated in one or more discrete stop positions.

The stop 305 overlaps a part of the heating member 220, 220′. The part of the heating member 220, 220′ overlapped in the first stop position is different to the part of the heating member 220, 220′ overlapped in the second stop position. The part of the heating member 220, 220′ overlapped by the stop 305 defines a non-useable extent of the heating member 220, 220′. The non-useable extent of the heating member 220, 220′ does not heat the portion of the article 110 received into the device 101 for heating. The non-useable extent of the heating member 220, 220′ does not define the heating zone 215. The first non-useable extent of the heating member 220, 220′ is unexposed to the heating zone 215. The part of the heating member 220, 220′ not overlapped by the stop 305 defines a useable extent of the heating member 220, 220′. The useable extent of the heating member 220, 220′ heats the portion of the article 110 received into the device 101 for heating so as to generate aerosol from the aerosol-generating material. The useable extent of the heating member 220, 220′ defines the heating zone 215. The useable extent of the heating member 220, 220′ is exposed to the heating zone 215.

In the first stop position, the heating arrangement 201, 201′ is configured to heat a first useable extent of the heating member 220, 220′ and to limit heating of a first non-useable extent of the heating member 220, 220′. In the second stop position, the heating arrangement 201, 201′ is configured to heat a second useable extent of the heating member 220, 220′ and to limit heating of a second non-useable extent of the heating member 220, 220′. In embodiments, the stop 305 may not overlap the heating member 220, 220′ in the first stop position. In such embodiments, the useable extent of the heating member 220, 220′ in the first stop position is the full extent of the heating member 220, 220′. In embodiments, the useable extent of the heating arrangement 201, 201′ is the useable extent of the heating member 220, 220′.

Each of FIGS. 3A, 4A and 5A shows the device 101 of FIG. 1A in a first configuration with the stop 305 being in a first stop position. Each of FIGS. 3B, 4B and 5B shows the device 101 of FIG. 1A in a second configuration with the stop 305 being in a second stop position. It will be understood that similar arrangements using the resistive configuration of FIG. 1B are possible.

The inductor arrangement 241 includes a plurality of inductor coils 242. The inductor coils 242 are disposed adjacent to each other and are aligned co-axially along the longitudinal axis of the device 101, however, other arrangements are envisaged. Each inductor coil of the plurality of inductor coils 242 acts as a distinct inductor element. Each of the inductor coils 242 comprises a portion of the heating arrangement 201. Each of the inductor coils 242 can be operated independently. Each of the inductor coils 242 can be deactivated, or at least partially deactivated, independently. The plurality of inductor coils 242 defines the full extent of the heating arrangement 201. Each of the inductor coils 242 is configured generate a varying magnetic field that penetrates at least a portion of the heating member 220. A portion of the heating member 220 arranged to be heated independently by one or more of the inductor coils 242 defines a heating portion of the heating member 220. The heating member 220 comprises at least two heating portions that are independently heatable. A juncture is defined between two adjacent heating portions. In embodiments the positions of the stop 305 are pre-determined. In such embodiments, one or more of the pre-determined positions may correspond to the juncture between adjacent heating portions. The stop 305 may be movable between different stop positions corresponding to the juncture of adjacent heating portions. In embodiments, one or more of the pre-determined positions may correspond to a juncture between adjacent inductor coils.

In the embodiments shown, the plurality of inductor 242 includes four coils-a first coil 242a, a second coil 242b, a third coil 242c and a fourth coil 242d. It will be appreciated that the number of coils shown is for illustrative purposes only. In embodiments, the plurality of inductor coils 242 comprise two, three, five or more coils instead. In the embodiments shown, the first, second and third coils 242a, 242b, 243c are substantially identical while the third coil 243c differs in at least one aspect. In embodiments, each of the coils in the plurality of coils is substantially identical. In embodiments, one or more of the coils in the plurality of coils may differ in at least one aspect. For example, one or more of the coils in the plurality of coils 242a may differ in number of turns, type of wire, coil and/or wire diameter, wire cross-section and/or material.

In the second stop position, one or more of the plurality of inductor coils 242 is at least partially deactivated. The deactivated coil of the plurality of inductor coil 242 is not supplied with a varying electric current and does not generate a varying magnetic field during use of the device 101. In embodiments, the deactivated coil of the plurality of inductor coils 242 may instead be supplied with a reduced current and may generate a negligible magnetic field. The remaining coils of the plurality of coils 242 (i.e. excluding any deactivated or partially deactivated coils) define the proportion of the heating arrangement 201 being operated to heat the heating zone 215.

In the embodiments, and with reference to FIGS. 3A and 3B, the heating zone 215 defined in a particular stop position spans across the entire useable extent W1, W2 of the heating arrangement in that particular stop position. The heating zone 215 extends from the base of the heating chamber 211 to the proximal end of the heating arrangement 201. The heating zone 215 extends from the stop surface 310 of the stop 305 to the proximal end of the heating arrangement 201. Advantageously, in any stop position the entire extent of the portion of the article 110 received by the heating arrangement 201 for heating is heated. Advantageously, in any stop position the non-useable portion of the heating arrangement 201 is deactivated or at least partially deactivated. As such, only the useable extent W1, W2 of the heating arrangement 201 is heated in any given stop position improving the energy efficiency of the device 101. The heating zone 215 is defined by the first useable extent W1 of the heating arrangement 201 in the first stop position and by the second useable extent W2 of the heating arrangement 201 in the second stop position.

The heating zone 215 has a first depth D1 in the first stop position and a second, different depth D2 in the second stop position. The first proportion PR1 of the heating arrangement 201 is operated to heat the heating zone 215 in the first stop position. The first proportion PR1 corresponds to the first useable extent W1 of the heating arrangement 201. The first proportion PR1 corresponds to the full extent of the heating arrangement 201 and the first useable extent W1 is the full useable extent of the heating arrangement 201. The first proportion PR1 of the heating arrangement 201 includes the first, second, third and fourth inductor coils 242a, 242b, 242c, 242d. The second proportion PR2 of the heating arrangement 201 is operated to heat the heating zone 215 in the second stop position. The second proportion PR2 corresponds to the second useable extent W2 of the heating arrangement 201. The first coil 242a is deactivated in the second stop position. The second proportion PR2 of the heating arrangement 201 includes the second, third and fourth inductor coils 242b, 242c, 242d.

In embodiments, such as the embodiment of FIGS. 4A and 4B, the first and second proportions PR1, PR2 of the heating arrangement 201 do not correspond to the first and second useable extents W1, W2 of the heating arrangement 201. In such embodiments, the heating zone 215 is provided in the useable extent W1, W2 of the heating arrangement 201 but only spans across part of the entire useable extent of the heating arrangement 201.

The heating zone 215 in the first stop position is defined by the first proportion PR1 of the heating arrangement 201 and the heating zone 215 in the second position is defined by the second proportion PR2 of the heating arrangement 201. In the first stop position, the first, second and third coils 242a, 242b, 242c are operated to define a first proportion PR1. In the first stop position, the fourth coil 242d is deactivated. In the second stop position, only the second and third coils 242b, 242c are operated to define the second proportion PR2. In the second stop position, the first and fourth coils 242a, 242d are deactivated. Advantageously, this allows for only portions of the article that contain aerosol generating material to be heated. Portion of the article 110 received into the heating arrangement 201 that do not comprise aerosol-generating material need not be heated unnecessarily improving the energy efficiency of the device 101.

In some embodiments, such as that of FIG. 3A, the first proportion PR1 corresponds to the full extent of the heating arrangement 201. In other embodiments, such as that of FIG. 4A, the first proportion PR1 does not corresponds to the full extent of the heating arrangement 201. In such embodiments, at least a portion of the heating arrangement 201 is partially deactivated in the first stop position.

In the embodiments, and with reference to FIGS. 3A and 3B, the first and second proportions PR1, PR2 of the heating arrangement 201 overlap. The first and second proportions PR1, PR2 include common portions of the heating arrangement 201. As shown, the first and second proportions PR1, PR2 both include the second, third and fourth inductor coils 242b, 242c, 242d being operated. The first proportion PR1 encompasses the second proportion PR2. In other words, all portions of the heating arrangement 201 operated in the second stop position are also operated in the first stop position. The first proportion PR1 is larger than the second proportion PR2. More portions of the heating arrangement 201 are operated in the first stop position than in the second stop position. In the second stop position, more portions of the heating arrangement 201 are deactivated than in the first stop position.

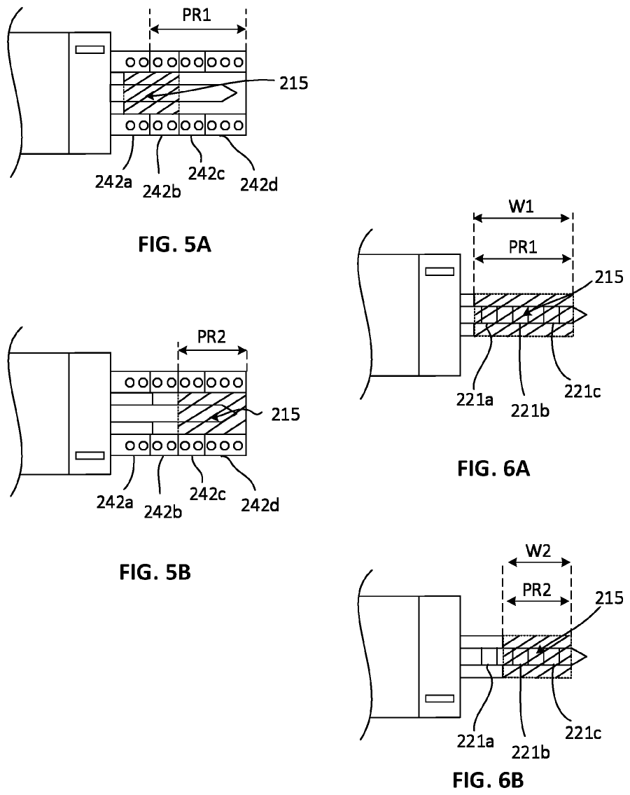

In other examples, such as the one of FIGS. 5A and 5B the first and second proportions PR1, PR2 are free from overlap. The first and second proportions PR1, PR2 do not include common portions of the heating arrangement. As shown, the first proportion PR1 includes the first and second inductor coils 242a, 242b being operated and the second proportion PR2 includes the third and fourth inductor coils 242c, 242d being operated. At least some of the portions of the heating arrangement 201 deactivated in the first and the second stop positions are different.

FIGS. 6A and 6B show the heating arrangement 201′ of FIG. 1B in a first configuration with the stop 305 being in a first stop position and in a second configuration with the stop being in a second stop position respectively. The heating arrangement 201′ comprises a heating member 220′. The heating member 220′ comprises a plurality of heating elements 221′. The heating elements 221′ are disposed spaced from one another along the longitudinal axis 102 of the device 101, however other arrangements are envisaged. Each of the heating elements 221′ comprises a portion the heating arrangement 201′. Each of the heating elements 221′ can be operated independently. Each of the heating elements 221′ can be deactivated, or at least partially deactivated, independently. The plurality of heating elements 221′ defines the full extent of the heating arrangement 201′. A portion of the heating member 220′ arranged to be heated independently by one or more of the heating elements 221′ defines a heating portion of the heating member 220′. The heating member 220′ comprises at least two heating portions that are independently heatable. A juncture is defined between heating portions of the heating member 220′.

In embodiments the positions of the stop 305 are pre-determined. In such embodiments, one or more of the pre-determined positions may correspond to a juncture between adjacent heating portions. The stop 305 may be movable between different stop positions corresponding to the juncture of adjacent heating portions. In embodiments, one or more of the pre-determined positions may correspond to a juncture between adjacent heating elements 221′.

Each of the heating elements 221′ comprises a heating band. In the embodiment shown, the plurality of heating elements 221′ includes three heating elements-a first heating band 221a, a second heating band 221b, a third heating band 221c. It will be appreciated that the number of heating elements 221′ shown is for illustrative purposes only. In embodiments, the plurality of heating elements 221′ comprise two, four or more heating elements instead. In the embodiment shown, the first, second and third heating bands 221a, 221b, 221c are substantially identical. In embodiments, one or more of the heating bands in the plurality of heating elements may differ in at least one aspect. For example, one or more of the heating bands in the plurality of heating elements may differ in material, coating, thickness, length, width and/or cross section.

In the second stop position, one or more of the plurality of heating elements 221′ is at least partially deactivated. The deactivated element of the plurality of heating elements 221′ is not supplied with an electric current. As such, the deactivated element is not heated. In embodiments, the deactivated element of the plurality of heating elements 221′ may instead be supplied with a reduced current and may generate a negligible amount of heat. In such embodiments, the negligible amount of heat generated is not sufficient to heat the aerosol generated material so as to generate aerosol. The remaining elements of the plurality of heating elements 221′ (i.e. excluding any deactivated or partially deactivated element) define the proportion of the heating arrangement 201′ being operated to heat the heating zone 215.

The heating zone 215 defined in a particular stop position spans across the entire useable extent of the heating arrangement 201′ in that particular stop position. The heating zone 215 extends from the base of the heating arrangement 201′ to the proximal end of the heating arrangement 201′. The heating zone 215 extends from the stop surface 310 of the stop 305 to the proximal end of the heating arrangement 201′.

Advantageously, in any stop position the entire extent of the portion of the article 110 received by the heating arrangement 201′ for heating is heated. Advantageously, in any stop position the non-useable portion of the heating arrangement 201′ is deactivated or at least partially deactivated. As such, only the useable extent W1, W2 of the heating arrangement 201′ is heated in any given stop position improving the energy efficiency of the device 101. The heating zone 215 is defined by the first useable extent W1 of the heating arrangement 201′ in the first stop position and by the second useable extent W2 of the heating arrangement 201′ in the second stop position.

The heating zone 215 has a first depth D1 in the first stop position and a second, different depth D2 in the second stop position. The first proportion PR1 of the heating arrangement 201′ is operated to heat the heating zone 215 in the first stop position. The first proportion PR1 corresponds to the first useable extent W1 of the heating arrangement 201′. The first proportion PR1 corresponds to the full extent of the heating arrangement 201′ and the first useable extent W1 is the full useable extent of the heating arrangement 201′. The first proportion PR1 of the heating arrangement 201′ includes the first, second and third heating bands 221a, 221b, 221c. The second proportion PR2 of the heating arrangement 201′ is operated to heat the heating zone 215 in the second stop position. The second proportion PR2 corresponds to the second useable extent W2 of the heating arrangement 201′. The first heating band 221a is deactivated in the second stop position. The second proportion PR2 of the heating arrangement includes the second and third heating bands 221b, 221c.

In embodiments, the first and second proportions of the heating arrangement 201′ do not correspond to the first and second useable extents W1, W2 of the heating arrangement 201′. In such embodiments, the heating zone 215 is provided in the useable extent W1, W2 of the heating arrangement 201′ but does not spans across the entire useable extent of the heating arrangement 201′. The heating zone 215 in the first stop position is defined by the first proportion PR1 of the heating arrangement and the heating zone 215 in the second position is defined by the second proportion PR2 of the heating arrangement 201′. Advantageously, this allows for only portions of the article that contain aerosol generating material to be heated. Portion of the article 110 received into the heating arrangement 201′ that do not comprise aerosol-generating material need not be heated unnecessarily improving the energy efficiency of the device 101.

Advantageously, the arrangement allows for different portions of the article 110 to be heated independently from one another. In embodiments, the article 110 may comprise a number of discrete portions with each portion comprising a different aerosol-generating material. In such embodiments, the heating arrangement is operable to selectively aerosolise the aerosol-generating material in one or more of the discrete portions. In such embodiments, the heating zone 215 in the first stop position is defined by the first proportion PR1 of the heating arrangement such that a first discrete portion of the article 110 is heated. The first discrete portion comprises a first aerosol-generating material. In such embodiments, the heating zone 215 in the second stop position is defined by the second proportion PR2 of the heating arrangement such that a second discrete portion of the article 110 is heated. The second discrete portion comprises a second aerosol-generating material. The first aerosol-generating material differs from the second aerosol-generating material in at least one aspect, for example in type of active material or type of flavourant. In such embodiments, the stop 305 may be moved during use of the device to allow for the provision of aerosol of different qualities.

Advantageously, depending on the stop position different aerosol can be generated from the same article. In such embodiments, the stop 305 may selectively abut the end portion of the article 110. For example, the stop 305 may be arranged to limit the extent by which the portion of the article 110 is received by the heating arrangement in only one of the first or the second position. In embodiments, the stop 305 may not abut the end portion of the article in either position.

The heating arrangement shown, in the embodiment of FIGS. 6A and 6B, is a resistive heating arrangement. In embodiments, the heating arrangement has a substantially similar configuration as shown but the heating member houses an inductor and the heating arrangement is an inductive heater arrangement instead.

In embodiments, the operating condition is a determined characteristic of the article received by the device 101 for heating. In embodiments, the characteristic is an article length. In embodiments the characteristic is a length of a portion of the article containing aerosol-generating material. The characteristic is determined in dependence on a property of the article detected by the article sensor. The heating arrangement is operated to produce a pre-determined heating profile.

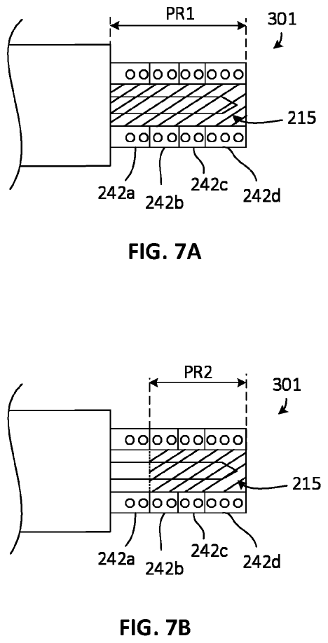

The heating profile comprises at least one of an operating temperature and a session length. In embodiments, the heating profile may vary along the length of the heating zone. The embodiment of FIGS. 7A and 7B is generally identical to that of FIGS. 6A and 6B but the stop 305 is omitted. The first proportion PR1 of the heating arrangement 301 is operated when a first property of an article is detected by the article sensor. The second proportion PR2 of the heating arrangement 301 is operated when a second, different property is detected by the article sensor.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device for generating an aerosol from aerosol-generating material comprising:
a heating arrangement configured to receive at least a portion of an article containing aerosol-generating material,
a stop arranged to abut an end of the portion of the article received by the heating arrangement to limit an extent by which the portion of the article is received by the heating arrangement,
wherein the stop is arranged to move relative to the heating arrangement between a first stop position and a second stop position to vary a useable extent of the heating arrangement, and
wherein in the second stop position a portion of the heating arrangement is at least partially deactivated.

2. The device of claim 1, wherein the useable extent of the heating arrangement defines a heating zone in which a portion of the article is heated.

3. The device of claim 2, wherein a depth of the heating zone varies between the first stop position and the second stop position.

4. The device of claim 2, wherein a first proportion of the heating arrangement is operated to heat the heating zone in the first stop position and a different second proportion of the heating arrangement is operated to heat the heating zone in the second position.

5. The device of claim 4, wherein the first and second proportions of the heating arrangement overlap.

6. The device of claim 2, wherein in the first stop position the full extent of the heating arrangement is operated to heat the heating zone.

7. The device of claim 2, wherein in the first stop position a first portion of the heating arrangement is at least partially deactivated and in the second stop position a second portion of the heating arrangement is at least partially deactivated.

8. The device of claim 7, wherein the portion of the heating arrangement that is at least partially deactivated is outside the heating zone.

9. The device of claim 2, wherein the heating arrangement comprises a heating member.

10. The device of claim 9, wherein the stop defines a useable extent of the heating member exposed to the heating zone, and a non-useable extent unexposed to the heating zone.

11. The device of claim 10, wherein when the stop is in the first stop position, the heating arrangement is configured to heat a first usable extent of the heating member and to limit heating of a first non-usable extent of the heating member; and wherein when the stop is in the second stop position, the heating arrangement is configured to heat a second usable extent of the heating member and to limit heating of a second non-useable extent of the heating member

12. The device of claim 9, wherein the heating member comprises at least two heating portions that are independently heatable and wherein the second stop position corresponds to the juncture of adjacent heating portions.

13. The device of claim 9, wherein the heating member comprises at least two heating elements; wherein the heating elements are heating bands and wherein the heating bands are selectively exposed dependent on stop position.

14. The device of claim 1, comprising a controller to control operation of the heating arrangement wherein, in a first operating condition, the controller is arranged to operate a first proportion of the heating arrangement and, in a second operating condition, the controller is arranged to operate a second proportion of the heating arrangement.

15. The device of claim 14, wherein the operating condition is a determined position of the stop.

16. The device of claim 15, wherein when the stop is in the first stop position, the controller is configured to operate the heating arrangement according to a first heating profile and when the stop is in the second stop position, the controller is configured to operate the heating arrangement according to a second heating profile and wherein the first heating profile is different to the second heating profile.

17. An aerosol provision system comprising:
an article comprising aerosol-generating material; and
an aerosol provision device according to claim 1.

18. A method of operating an aerosol provision device comprising a heating arrangement configured to receive at least a portion of an article containing aerosol-generating material, the method comprising:
operating the device in a first operating condition in which the heating arrangement is operated and the stop is in a first stop position, wherein the stop is arranged to abut an end of the portion of the article received by the heating arrangement to limit an extent by which the portion of the article is received by the heating arrangement, and
operating the device in a second operating condition in which the stop is in a second stop position, in which a portion of the heating arrangement is at least partially deactivated and the stop has been moved relative to the heating arrangement between the first stop position and the second stop position to vary a useable extent of the heating arrangement.

19. The method of claim 18, comprising:
determining whether a stop is in a first stop position or a second stop position; and at least partially deactivating a portion of the heating arrangement when the stop is determined to be in the second stop position.

20. An aerosol provision device for generating an aerosol from aerosol-generating material comprising:
a heating arrangement configured to receive at least a portion of an article containing aerosol-generating material;
an article sensor; and
a controller,
wherein the controller is configured to:
determine a characteristic of the article in dependence on a property of the article detected by the article sensor,
select a heating profile of the heating arrangement in dependence on the determined characteristic, and
operate the heating arrangement based on the selected heating profile.
